(19) United States
(12) Patent Application Publication
(10) Pub. No.: US 2026/0065706 A1
(43) Pub. Date: Mar. 5, 2026

(54) SYSTEM AND METHOD FOR AUTOMATED EXTRACTION OF CONTEXTUAL INFORMATION FROM DATA USING LARGE MULTIMODAL MODEL

(71) Applicant: INTELLECT DESIGN ARENA LIMITED, Chennai (IN)

(72) Inventors: Kishore Kumar Uthirapathy, Chennai (IN); Darshan N, Bangalore (IN); Sai Kiran Bandaru, Chennai (IN)

(21) Appl. No.: 19/312,887

(22) Filed: Aug. 28, 2025

(30) Foreign Application Priority Data
Aug. 30, 2024 (IN) 202441065743

(51) Int. Cl. G06V 30/416; G06F 40/40; G06V 10/776; G06V 30/10

(52) U.S. Cl. CPC G06V 30/416; G06F 40/40; G06V 10/776; G06V 30/10

(57) ABSTRACT

A system and method for automated extraction of contextual information from a set of data using an LMM is provided. The method begins by splitting the set of data into sub-data based on logical boundaries and converting each sub-data into an image. These images are then processed using a computer vision model and optical image recognition to extract metadata and positional coordinates. The images, extracted metadata, and positional coordinates are integrated into a custom prompt for the LMM. This prompt is processed to obtain relevant data points, which are subsequently validated for accuracy using a trained validation model that considers content density versus output records, regex pattern-based record matching scores, and template-based records approximation scores. An LLM is then used to normalize headers in the relevant data points. Finally, the method automatically extracts contextual information by generating responses to user queries on the normalized relevant data points using the LLM.

### CROSS REFERENCE TO RELATED APPLICATIONS

This application claims priority to Indian Patent Application No. 202441065743, filed Aug. 30, 2024, the contents of which are incorporated herein by reference in its entirety for all purposes.

### TECHNICAL FIELD

The embodiments herein relate to automated data extraction, and more particularly, to a system and method for automated extraction of contextual information from data using large multimodal model.

### DESCRIPTION OF THE RELATED ART

Loss runs documents are critical sources of information in the insurance industry, containing detailed claims history, loss dates, types of claims filed, amounts paid out, and outstanding reserves. These documents are essential for insurance carriers to assess risk, determine pricing, and make informed coverage decisions. However, the format and content of loss runs documents can vary significantly across brokers and lines of business, thereby making data extraction and processing challenging.

Existing approaches to data extraction from loss runs documents often rely on basic optical character recognition (OCR) techniques combined with simple natural language processing (NLP) models. These methods provide a limited understanding of the complex interplay between various data points in loss runs reports, failing to capture the context and relationships between different pieces of information.

Furthermore, current solutions struggle to handle the vast diversity of document formats and layouts used by thousands of brokers and carriers globally. This variation in data presentation hinders accurate and consistent extraction, leading to potential errors in underwriting decisions and risk assessments. The inability to adapt to different templates and structures limits the effectiveness of existing systems in processing the enormous volume of loss runs data in the insurance industry.

Moreover, traditional data extraction techniques often lack the ability to correlate visual aspects of documents with the extracted textual data. Without this visual context, it becomes challenging to accurately interpret complex tables, headers, and footnotes that are common in loss runs documents, leading to potential misinterpretation of critical information.

Furthermore, the dynamic nature of the insurance industry, with evolving reporting standards and document formats, necessitates a flexible and adaptable approach to data extraction. Existing methods often struggle to keep pace with these changes, requiring frequent manual updates and reconfiguration, which can be time-consuming and error-prone.

Therefore, there is a need for a system and method for automated extraction of contextual information from data using large multimodal model.

### SUMMARY

In view of the foregoing, an embodiment herein provides a method for automated extraction of contextual information from data using large multimodal model (LMM). The method includes (i) splitting the set of data into one or more sub-data based on logical boundaries and converting each sub-data into an image, (ii) processing the image using a computer vision model and an optical image recognition method to obtain extracted metadata and positional coordinates of the extracted metadata, (iii) integrating the image with the extracted metadata and the positional coordinates of the extracted metadata into a custom prompt for the LMM, (iv) processing the custom prompt for the LMM to obtain relevant data points, (v) validating the relevant data points for accuracy using a validation model that is trained on features comprising content density versus output records, a regex pattern-based record matching score and a template-based records approximation score, (vi) processing a prompt with a large language model (LLM) to normalize headers in the relevant data points to obtain normalized relevant data points, and (vii) generating response to queries on the normalized relevant data points obtained from a user using the LLM for performing automated extraction of contextual information from the set of data using the LMM.

The method is of advantage that the method uses the LMM combined with computer vision and optical character recognition (OCR), thereby enabling effective handling of diverse document formats and layouts. This ensures high accuracy in extracting metadata and relevant data points, regardless of the complexity or presentation of the documents. The integration of the metadata and positional coordinates into custom prompts for the LMM significantly enhances the contextual understanding and accuracy of the extracted information. Further, the inclusion of a validation model trained on features such as content density versus output records, regex pattern-based record matching score, and template-based records approximation score ensures robust accuracy checks, reducing the likelihood of errors and improving overall data quality.

Furthermore, the utilization of the LLM for normalizing headers and titles in the relevant data points ensures consistency across different datasets, making the extracted information more reliable and easier to integrate into downstream systems. This method not only enhances the accuracy of the data but also significantly improves the functioning of a computer by optimizing data processing workflows. The method enables processing of large volumes of documents or pages in parallel, supported by priority-based load balancing and dynamic scaling of serverless resources, thereby enhancing its scalability and efficiency. This parallel processing capability reduces latency and maximizes resource utilization, leading to faster and more efficient data handling and analysis.

In some embodiments, the method includes improving the accuracy of the extracted metadata, upon determining that the accuracy of the extracted metadata is less than a threshold, by processing the image using a deep learning model to obtain the extracted metadata.

In some embodiments, the deep learning model is trained based on predefined templates to identify and extract information from the positional coordinates and context of the extracted metadata.

In some embodiments, the method includes automatically extracting metadata for a type and a sub-type of the set of data based on a classification by a deep learning model and populating the normalized relevant data points into a standardised set of data format.

In some embodiments, the method includes processing of multiple sets of data in parallel by queueing up LLM requests with priority-based load balancing.

In another aspect, there is provided a system for automated extraction of contextual information from a set of data using a large multimodal model (LMM), the system comprising an automated extraction server comprising a processor and a memory being configured to perform (i) splitting the set of data into one or more sub-data based on logical boundaries and converting each sub-data into an image, (ii) processing the image using a computer vision model and an optical image recognition method to obtain extracted metadata and positional coordinates of the extracted metadata, (iii) integrating the image with the extracted metadata and the positional coordinates of the extracted metadata into a custom prompt for the LMM, (iv) processing the custom prompt for the LMM to obtain relevant data points, (v) validating the relevant data points for accuracy using a validation model that is trained on features comprising content density versus output records, a regex pattern-based record matching score and a template-based records approximation score, (vi) processing a prompt with a large language model (LLM) to normalize headers in the relevant data points to obtain normalized relevant data points, and (vii) generating response to queries on the normalized relevant data points obtained from a user using the LLM for performing automated extraction of contextual information from the set of data using the LMM.

The system is of advantage that the system uses the LLM combined with computer vision and optical character recognition (OCR), thereby enabling effective handling of diverse document formats and layouts. This ensures high accuracy in extracting metadata and relevant data points, regardless of the complexity or presentation of the documents. The integration of the metadata and positional coordinates into custom prompts for the LMM significantly enhances the contextual understanding and accuracy of the extracted information. Further, the inclusion of a validation model trained on features such as content density versus output records, regex pattern-based record matching score, and template-based records approximation score ensures robust accuracy checks, reducing the likelihood of errors and improving overall data quality.

Furthermore, the utilization of the LLM for normalizing headers and titles in the relevant data points ensures consistency across different datasets, making the extracted information more reliable and easier to integrate into downstream systems. This system not only enhances the accuracy of the data but also significantly improves the functioning of a computer by optimizing data processing workflows. The system enables processing of large volumes of documents or pages in parallel, supported by priority-based load balancing and dynamic scaling of serverless resources, thereby enhancing its scalability and efficiency. This parallel processing capability reduces latency and maximizes resource utilization, leading to faster and more efficient data handling and analysis.

In some embodiments, the system further performs improving the accuracy of the extracted metadata, upon determining that the accuracy of the extracted metadata is less than a threshold, by processing the image using a deep learning model to obtain the extracted metadata.

In some embodiments, the deep learning model is trained based on predefined templates to identify and extract information from the positional coordinates and context of the extracted metadata.

In some embodiments, the system further performs automatically extracting metadata for a type and a sub-type of the set of data based on a classification by a deep learning model and populating the normalized relevant data points into a standardised set of data format.

In some embodiments, the system further performs processing of multiple sets of data in parallel by queueing up LLM requests with priority-based load balancing.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram of a system for automated extraction of contextual information from a set of data using a large multimodal model (LMM), according to some embodiments herein;

FIG. 2 is an exploded view of an automated extraction server of FIG. 1, according to some embodiments herein;

FIG. 3A is a flow diagram illustrating automated extraction and normalization of contextual information from documents for generation of use-case specific data outputs according to some embodiments herein;

FIG. 3B is a flow diagram illustrating components of a data extraction and processing pipeline to produce a final output based on business rules, according to some embodiments herein;

FIG. 4 is a flow diagram that illustrates a method for automated extraction of contextual information from a set of data using an LMM, according to some embodiments herein; and

FIG. 5 is a schematic diagram of a computer architecture in accordance with the embodiments herein.

### DETAILED DESCRIPTION OF THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The term “large language model” refers to an advanced artificial intelligence (AI) system trained on vast amounts of text data to understand, generate, and manipulate human language. For example, GPT-3.

The term “large multimodal model” refers to an AI system capable of processing and integrating multiple types of data, such as text, images, and audio, to generate comprehensive insights. For example, Contrastive Language-Image Pre-training (CLIP) model from OpenAI, which understands images and their associated textual descriptions.

The term “contextual information” refers to data that provides additional meaning and context to other data, aiding in accurate interpretation and analysis. For example, in an insurance claim document, contextual information for a claimant's name “John Doe” includes the claim number “12345,” the date of the incident “01/15/2022,” and the type of claim “medical,” which together are called contextual information and enable interpreting John Doe's claim details.

The term “logical boundaries” refers to divisions within a dataset that separate it into meaningful segments based on logical criteria. For example, splitting a document into individual pages or sections based on headings or content changes.

The term “extracted metadata” refers to information retrieved from a document that describes its content and structure. For example, titles, headings, author names, and dates extracted from a research paper.

The term “positional coordinates of the extracted metadata” refers to specific location details of metadata within a document. For example, positional coordinates (left: 56, top: 72) indicating where a title is located on a page.

The term “custom prompt” refers to a customized input query designed to instruct an LLM or an LMM on how to process specific data. For example, a prompt guiding an LMM to extract relevant information from a loss run report.

The term “relevant data points” refers to specific pieces of data identified as important and extracted for further processing. For example, claim numbers and dates in an insurance report.

The term “normalized relevant data points” refers to extracted data that has been standardized to ensure consistency across datasets. For example, converting various date formats into a single standardized format like “MM/DD/YYYY”.

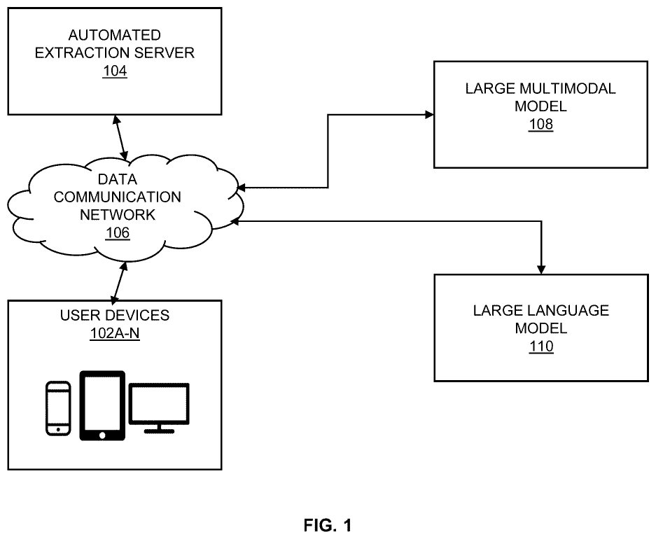

As mentioned there is a need for an innovative, multimodal approach to data extraction that integrates diverse data streams from loss runs documents, adapts to various formats and layouts, and provides accurate, context-aware results for improved insurance underwriting and risk assessment processes. Embodiments herein provide a system and method for automated extraction of contextual information from data using large multimodal model. Referring now to the drawings, and more particularly to FIGS. 1 through 5, where similar reference characters denote corresponding features consistently throughout the figures, preferred embodiments are shown.

FIG. 1 is a block diagram of a system for automated extraction of contextual information from a set of data using a large multimodal model (LMM), according to some embodiments herein. The system includes user devices 102A-N, an automated extraction server 104, a data communication network 106, a large multimodal model (LMM) 108, and a large language model (LLM) 110. In some embodiments, the one or more user devices 102A-N, without limitation, is an internet enabled device and may include a mobile phone, a tablet, a desktop computer, a laptop computer, and the like.

In some embodiments, the user devices 102A-N are deployed at insurance companies for data input. The placement of the user devices 102A-N may be configured to cover diverse departments within insurance companies, ensuring representative data collection. The placement may be adjusted periodically to account for changes in document types and other factors affecting insurance data processing. The user devices 102A-N may operate continuously to capture data during times of underwriting activity.

The automated extraction server 104 is configured to split the set of data into one or more sub-data based on logical boundaries and convert each sub-data into an image. The automated extraction server 104 processes the image using a computer vision model and an optical image recognition method to obtain extracted metadata and positional coordinates of the extracted metadata. The automated extraction server 104 integrates the image with the extracted metadata and the positional coordinates of the extracted metadata into a custom prompt for the LMM 108.

The automated extraction server 104 processes the custom prompt for the LMM 108 to obtain relevant data points. The automated extraction server 104 validates the relevant data points for accuracy using a validation model that is trained on features comprising content density versus output records, a regex pattern-based record matching score and a template-based records approximation score.

The automated extraction server 104 processes a prompt with the LLM 110 to normalize headers in the relevant data points to obtain normalized relevant data points. The automated extraction server 104 generates response to queries on the normalized relevant data points obtained from a user using the LLM 110 for performing automated extraction of contextual information from the set of data using the LMM 108.

The system is of advantage that the system uses the LMM 108 combined with computer vision and optical character recognition (OCR), thereby enabling effective handling of diverse document formats and layouts. This ensures high accuracy in extracting metadata and relevant data points, regardless of the complexity or presentation of the documents. The integration of the metadata and positional coordinates into custom prompts for the LMM 108 significantly enhances the contextual understanding and accuracy of the extracted information. Further, the inclusion of a validation model trained on features such as content density versus output records, regex pattern-based record matching score, and template-based records approximation score ensures robust accuracy checks, reducing the likelihood of errors and improving overall data quality.

Furthermore, the utilization of the LLM 110 for normalizing headers and titles in the relevant data points ensures consistency across different datasets, making the extracted information more reliable and easier to integrate into downstream systems. This system not only enhances the accuracy of the data but also significantly improves the functioning of a computer by optimizing data processing workflows. The system enables processing of large volumes of documents or pages in parallel, supported by priority-based load balancing and dynamic scaling of serverless resources, thereby enhancing its scalability and efficiency. This parallel processing capability reduces latency and maximizes resource utilization, leading to faster and more efficient data handling and analysis.

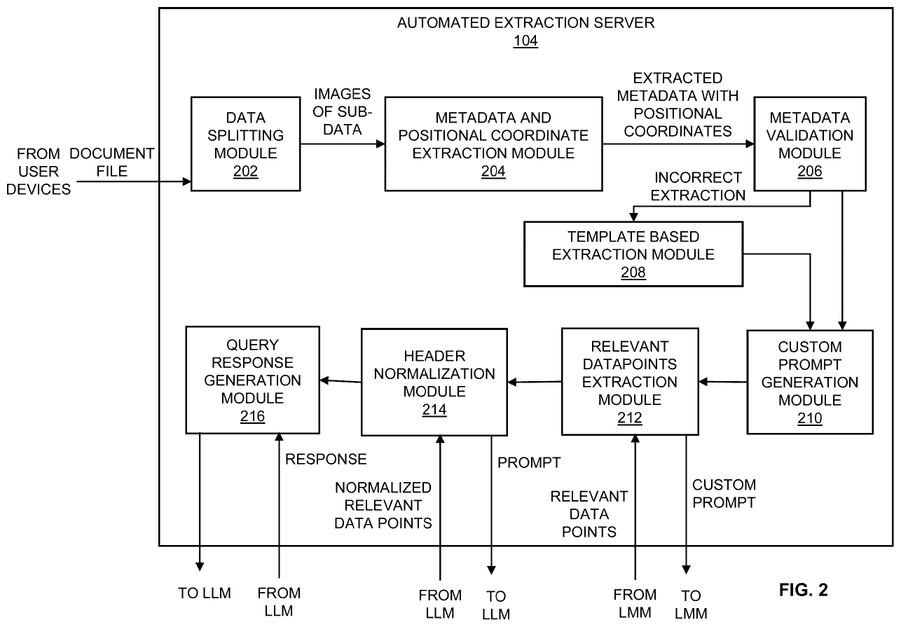

FIG. 2 is an exploded view of the automated extraction server 104 of FIG. 1, according to some embodiments herein. The automated extraction server 104 includes a data splitting module 202, a metadata and positional coordinate extraction module 204, a metadata validation module 206, a template based extraction module 208, a custom prompt generation module 210, a relevant datapoints extraction module 212, a header normalization module 214 and a query response generation module 216.

The data splitting module 202 is configured to split the set of data into one or more sub-data based on logical boundaries and converting each sub-data into an image.

The metadata and positional coordinate extraction module 204 is configured to process the image using a computer vision model and an optical image recognition method to obtain extracted metadata and positional coordinates of the extracted metadata.

The metadata validation module 206 may identify an incorrect extraction performed by the metadata and positional coordinate extraction module 204, thereby invoking template based extraction module 208 to perform template based extraction of metadata.

The custom prompt generation module 210 integrates the image with the extracted metadata and the positional coordinates of the extracted metadata into a custom prompt for the LMM 108.

The relevant datapoints extraction module 212 processes the custom prompt with the LMM 108 to obtain relevant data points. The relevant datapoints extraction module 212 validates the relevant data points for accuracy using a validation model that is trained on features comprising content density versus output records, a regex pattern-based record matching score and a template-based records approximation score.

The header normalization module 214 processes a prompt with the LLM 110 to normalize headers in the relevant data points to obtain normalized relevant data points.

The query response generation module 216 generates response to queries on the normalized relevant data points obtained from a user using the LLM 110 for performing automated extraction of contextual information from the set of data using the LMM 108.

In some embodiments, automated extraction server 104 improves the accuracy of the extracted metadata, upon determining that the accuracy of the extracted metadata is less than a threshold, by processing the image using a deep learning model to obtain the extracted metadata.

In some embodiments, the deep learning model is trained based on predefined templates to identify and extract information from the positional coordinates and context of the extracted metadata.

In some embodiments, automated extraction server 104 further performs automatically extracting metadata for a type and a sub-type of the set of data based on a classification by a deep learning model and populating the normalized relevant data points into a standardised set of data format.

In some embodiments, automated extraction server 104 further performs processing of multiple sets of data in parallel by queueing up LLM 110 requests with priority-based load balancing.

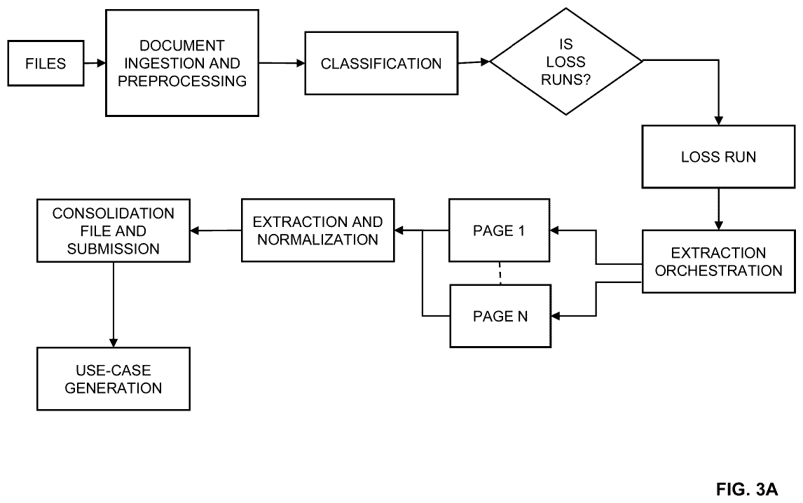

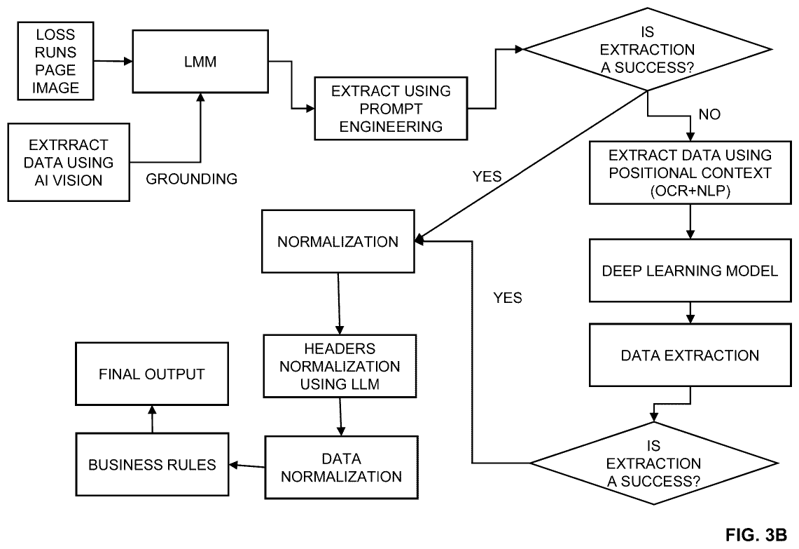

FIG. 3A is a flow diagram illustrating automated extraction and normalization of contextual information from documents for generation of use-case specific data outputs according to some embodiments herein. The process begins with the ingestion of files into the system, indicated by the block “FILES.” The files are then processed through the “DOCUMENT INGESTION AND PREPROCESSING” block, that handles the initial intake of documents. In some embodiments, multiple sets of data is processed in parallel by queuing up LLM requests with priority-based load balancing, optimizing computer resource utilization and improving processing efficiency.

Following ingestion, the documents undergo a “CLASSIFICATION” step, where the documents are analyzed to determine type. In some embodiments, the process includes utilizing a specially trained deep learning model to classify documents and their sub-types, such as Loss Summary, No Claims Report, and No Known Loss Report, enhancing the accuracy and relevance of the extracted metadata.

A decision point “IS LOSS RUNS?” determines if the document is a loss run report. If classified as a loss run, the process proceeds with the “LOSS RUN” block, indicating the specific type of document being processed. The next stage involves “EXTRACTION ORCHESTRATION,” where the loss run documents are segmented into individual pages (PAGE 1 through PAGE N) for detailed analysis. Each page is then processed through the “EXTRACTION AND NORMALIZATION” block, where relevant data is extracted and normalized for consistency. The validation of relevant data points for accuracy is performed using a validation model trained on features including content density versus output records, regex pattern-based record matching score, and template-based records approximation score, ensuring high precision and reliability of the extracted data.

The extracted and normalized data is subsequently consolidated in the “CONSOLIDATION FILE AND SUBMISSION” block, ensuring that all the processed pages are combined into a single, coherent file. Finally, the consolidated data is utilized for generating specific use-cases, as indicated by the “USE-CASE GENERATION” block.

FIG. 3B is a flow diagram illustrating components of a data extraction and processing pipeline to produce a final output based on business rules, according to some embodiments herein. The process begins with a “LOSS RUNS PAGE IMAGE,” which is analyzed using “EXTRACT DATA USING AI VISION.” AI vision techniques are utilized to extract initial data and provide contextual grounding for the LMM, thereby enhancing the accuracy and depth of the extracted information. The extracted data is then grounded in context using a “LMM” (Large Multimodal Model), as indicated by the “GROUNDING” block.

In the “EXTRACT DATA USING AI VISION” block, the process analyzes the image of a loss runs page. The AI vision output for a typical loss report document includes a detailed description of individual claims, including claimant names, claim numbers, and dates related to each incident, as well as financial details such as amounts paid and outstanding reserves. As an example, a report may list details for workers' compensation claims associated with a fitness systems corporation, providing a summary of claims processed within a given timeframe, and including the branding from the insurance provider to indicate its official nature. The AI vision output may include:
HKRM FITNESS SYSTEMS, INC.
Policy Number(s): 82312244
Detail Loss Report
TRAVELERS
Losses From: 09/01/2018 To 09/01/2023
WC—WORKERS COMP
Claimant Names: NATALIE GONZALES, DEREK SANTOS, MORGAN FIELDS
Claim Numbers: FM1234, FC1235, FM1236
Accident Dates: 08/13/2019, 10/17/2018, 09/13/2019
Notice Dates: 09/10/2019, 10/19/2018, 09/17/2019
Close Dates: 11/21/2019, 01/17/2019, 01/30/2020
O/C: C
Total Claims: Various amounts
Medical: Various amounts
Expense: Various amounts
Total Claim Count: Various numbers
Losses as of: 06/06/2023
Run Date: 06/08/2023

The LMM processes the grounded data and utilizes prompt engineering to obtain relevant data points as illustrated in the block “EXTRACT USING PROMPT ENGINEERING”.

A decision point “IS EXTRACTION A SUCCESS?” determines the success of this extraction process. If successful, the process moves to “NORMALIZATION,” where the data is standardized. If the initial extraction is not successful, the process involves “EXTRACT DATA USING POSITIONAL CONTEXT (OCR+NLP)” to extract data using positional context from Optical Character Recognition (OCR) combined with Natural Language Processing (NLP). In the “EXTRACT DATA USING POSITIONAL CONTEXT (OCR+NLP)” block, the process utilizes OCR to convert the textual content within the document images into machine-readable text. The OCR output includes detailed information such as positional coordinates of the extracted text.

As an example, the OCR output might include metadata indicating the vertical and horizontal dimensions of the document, the tilt angle, and segmentation details of the text. An example output could detail specific terms like “HKRM,” identified with high confidence, along with their positional coordinates (e.g., left: 56, top: 72, width: 92, height: 25). This positional information is utilized to accurately map the text within the document.

This data is then processed by a “DEEP LEARNING MODEL” for further extraction, as indicated by the “DATA EXTRACTION” block.

A subsequent decision point “IS EXTRACTION A SUCCESS?” determines if this secondary extraction is successful. Successful extraction leads to the “NORMALIZATION” step, where headers are normalized using “HEADERS NORMALIZATION USING LLM” (Large Language Model), followed by “DATA NORMALIZATION” to ensure consistency in the data. In some embodiments, The system process incorporates a human-in-the-loop (HITL) flow where manual validation and correction of extracted data are performed, and feedback is used for continuous model retraining.

The normalized data is then processed according to “BUSINESS RULES” to generate a “FINAL OUTPUT”.

The normalized data is further processed by applying business rules, that may include, but are not limited to, validation criteria specific to the document type, such as ensuring the presence of loss history or identifying discrepancies in reported data, to ensure the output data meets industry standards and requirements.

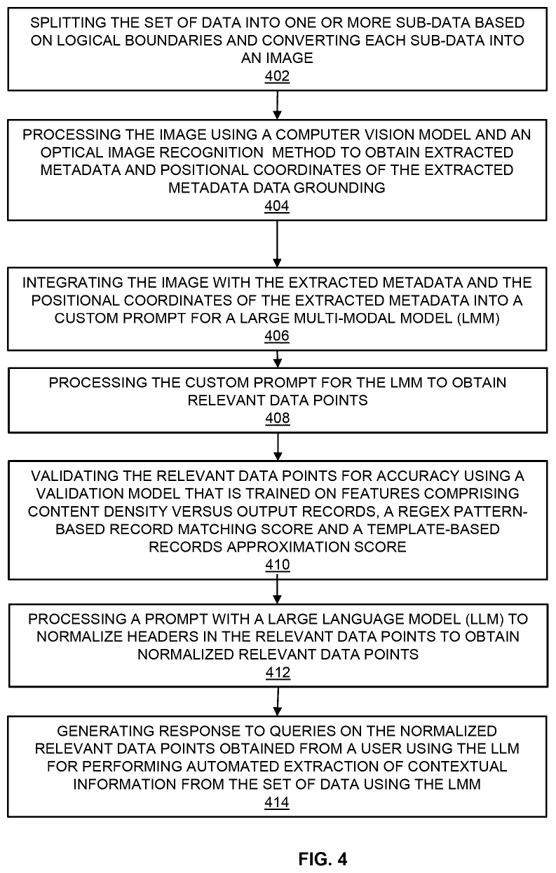

FIG. 4 is a flow diagram that illustrates a method for automated extraction of contextual information from a set of data using an LMM, according to some embodiments herein. At step 402, the method comprises splitting the set of data into one or more sub-data based on logical boundaries and converting each sub-data into an image. At step 404, the method comprises processing the image using a computer vision model and an optical image recognition method to obtain extracted metadata and positional coordinates of the extracted metadata. At step 406, the method comprises integrating the image with the extracted metadata and the positional coordinates of the extracted metadata into a custom prompt for a large multi-modal model (LMM). At step 408, the method comprises processing the custom prompt for the LMM to obtain relevant data points. At step 410, the method comprises validating the relevant data points for accuracy using a validation model that is trained on features comprising content density versus output records, a regex pattern-based record matching score and a template-based records approximation score. At step 412, the method comprises processing a prompt with a large language model (LLM) to normalize headers in the relevant data points to obtain normalized relevant data points. At step 414, the method comprises generating response to queries on the normalized relevant data points obtained from a user using the LLM for performing automated extraction of contextual information from the set of data using the LMM.

The method is of advantage that the method uses the large multimodal model (LMM) combined with computer vision and optical character recognition (OCR), thereby enabling effective handling of diverse document formats and layouts. This ensures high accuracy in extracting metadata and relevant data points, regardless of the complexity or presentation of the documents. The integration of the metadata and positional coordinates into custom prompts for the LMM significantly enhances the contextual understanding and accuracy of the extracted information. Further, the inclusion of a validation model trained on features such as content density versus output records, regex pattern-based record matching score, and template-based records approximation score ensures robust accuracy checks, reducing the likelihood of errors and improving overall data quality.

Furthermore, the utilization of the LLM for normalizing headers and titles in the relevant data points ensures consistency across different datasets, making the extracted information more reliable and easier to integrate into downstream systems. This method not only enhances the accuracy of the data but also significantly improves the functioning of a computer by optimizing data processing workflows. The method enables processing of large volumes of documents or pages in parallel, supported by priority-based load balancing and dynamic scaling of serverless resources, thereby enhancing its scalability and efficiency. This parallel processing capability reduces latency and maximizes resource utilization, leading to faster and more efficient data handling and analysis.

In some embodiments, the method includes improving the accuracy of the extracted metadata, upon determining that the accuracy of the extracted metadata is less than a threshold, by processing the image using a deep learning model to obtain the extracted metadata.

In some embodiments, the deep learning model is trained based on predefined templates to identify and extract information from the positional coordinates and context of the extracted metadata.

In some embodiments, the method includes automatically extracting metadata for a type and a sub-type of the set of data based on a classification by a deep learning model and populating the normalized relevant data points into a standardised set of data format.

In some embodiments, the method includes processing of multiple sets of data in parallel by queueing up LLM requests with priority-based load balancing.

The embodiments herein may include a computer program product configured to include a pre-configured set of instructions, which when performed, can result in actions as stated in conjunction with the methods described above. In an example, the pre-configured set of instructions can be stored on a tangible non-transitory computer readable medium or a program storage device. In an example, the tangible non-transitory computer readable medium can be configured to include the set of instructions, which when performed by a device, can cause the device to perform acts similar to the ones described here. Embodiments herein may also include tangible and/or non-transitory computer-readable storage media for carrying or having computer executable instructions or data structures stored thereon.

Generally, program modules utilized herein include routines, programs, components, data structures, objects, and the functions inherent in the design of special-purpose processors, etc. that perform particular tasks or implement particular abstract data types. Computer executable instructions, associated data structures, and program modules represent examples of the program code means for executing steps of the methods disclosed herein. The particular sequence of such executable instructions or associated data structures represents examples of corresponding acts for implementing the functions described in such steps.

The embodiments herein can include both hardware and software elements. The embodiments that are implemented in software include but are not limited to, firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

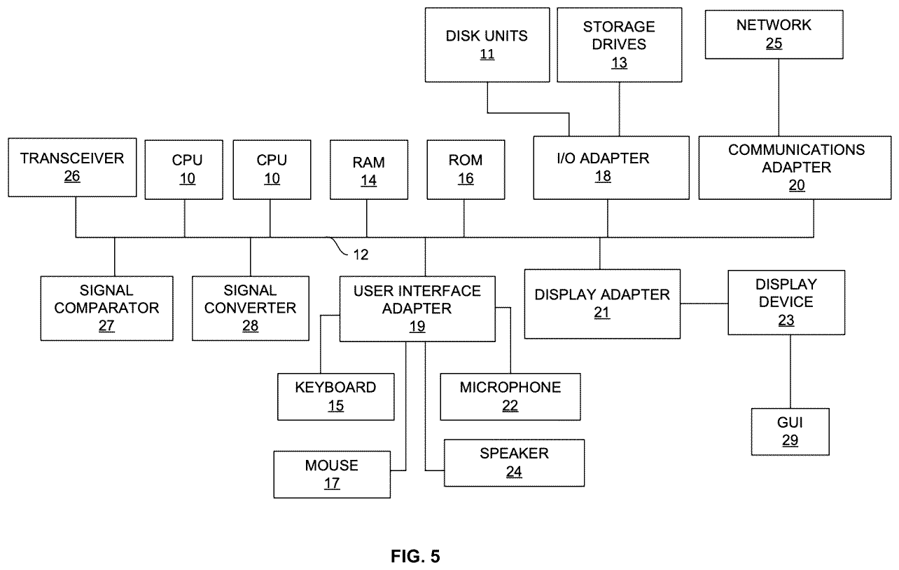

A representative hardware environment for practicing the embodiments herein is depicted in FIG. 5, with reference to FIGS. 1 through 4. This schematic drawing illustrates a hardware configuration of a server/computer system/user device in accordance with the embodiments herein. The viewer device 104 includes at least one processing device 10. The special-purpose CPUs 10 are interconnected via system bus 12 to various devices such as a random-access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The viewer device 104 can read the inventive instructions on the program storage devices and follow these instructions to execute the methodology of the embodiments herein. The viewer device 104 further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23, which provides a graphical user interface (GUI) 29 of the output data in accordance with the embodiments herein, or which may be embodied as an output device such as a monitor, printer, or transmitter, for example. Further, a transceiver 26, a signal comparator 27, and a signal converter 28 may be connected with the bus 12 for processing, transmission, receipt, comparison, and conversion of electric or electronic signals.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope.

What is claimed is:

1. A method for automated extraction of contextual information from a set of data using a large multimodal model (LMM) (108), the method comprising:
splitting the set of data into one or more sub-data based on logical boundaries and converting each sub-data into an image;
processing the image using a computer vision model and an optical image recognition method to obtain extracted metadata and positional coordinates of the extracted metadata;
integrating the image with the extracted metadata and the positional coordinates of the extracted metadata into a custom prompt for the LMM (108);
processing the custom prompt for the LMM (108) to obtain relevant data points;
validating the relevant data points for accuracy using a validation model that is trained on features comprising content density versus output records, a regex pattern-based record matching score and a template-based records approximation score;
processing a prompt with a large language model (LLM) (110) to normalize headers in the relevant data points to obtain normalized relevant data points; and
generating response to queries on the normalized relevant data points obtained from a user using the LLM (110) for performing automated extraction of contextual information from the set of data using the LMM (108).

2. The method of claim 1, further comprising improving the accuracy of the extracted metadata, upon determining that the accuracy of the extracted metadata is less than a threshold, by processing the image using a deep learning model to obtain the extracted metadata.

3. The method of claim 2, wherein the deep learning model is trained based on predefined templates to identify and extract information from the positional coordinates and context of the extracted metadata.

4. The method of claim 1, further comprising automatically extracting metadata for a type and a sub-type of the set of data based on a classification by a deep learning model and populating the normalized relevant data points into a standardised set of data format.

5. The method of claim 1, further comprising processing of multiple sets of data in parallel by queueing up LLM (110) requests with priority-based load balancing.

6. A system for automated extraction of contextual information from a set of data using a large multimodal model (LMM) (108), the system comprising:
an automated extraction server (104) comprising a processor and a memory being configured to perform:
splitting the set of data into one or more sub-data based on logical boundaries and converting each sub-data into an image;
processing the image using a computer vision model and an optical image recognition method to obtain extracted metadata and positional coordinates of the extracted metadata;
validating the extracted metadata for accuracy using a validation model that is trained on features comprising content density versus output records, a regex pattern-based record matching score and a template-based records approximation score;
integrating the image with the extracted metadata and the positional coordinates of the extracted metadata into a custom prompt for the LMM (108);
processing the custom prompt for a large language model (LLM) (110) to obtain relevant data points;
processing a prompt with the LLM (110) to normalize headers in the relevant data points to obtain normalized relevant data points; and
generating response to queries on the normalized relevant data points obtained from a user using the LLM (110) for performing automated extraction of contextual information from the set of data using the LMM (108).

7. The system of claim 6, further comprising improving the accuracy of the extracted metadata, upon determining that the accuracy of the extracted metadata is less than a threshold, by processing the image using a deep learning model to obtain the extracted metadata.

8. The system of claim 7, wherein the deep learning model is trained based on predefined templates to identify and extract information from the positional coordinates and context of the extracted metadata.

9. The system of claim 6, further comprising automatically extracting metadata for a type and a sub-type of the set of data based on a classification by a deep learning model and populating the normalized relevant data points into a standardised set of data format.

10. The system of claim 6, further comprising processing of multiple sets of data in parallel by queueing up LLM (110) requests with priority-based load balancing.
